(19) United States
(12) Patent Application Publication
(10) Pub. No.: US 2026/0032521 A1
(43) Pub. Date: Jan. 29, 2026

(54) MULTICAST SERVICE PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventor: Jiamin LIU, Dongguan (CN)

(21) Appl. No.: 19/342,708

(22) Filed: Sep. 29, 2025

Related U.S. Application Data
(63) Continuation of application No. PCT/CN2024/086349, filed on Apr. 7, 2024.

(30) Foreign Application Priority Data
Apr. 7, 2023 (CN) 202310368580.9

(51) Int. Cl. H04W 36/00; H04W 36/08

(52) U.S. Cl. CPC H04W 36/0007; H04W 36/08

(57) ABSTRACT

This application discloses a multicast service processing method and apparatus, a terminal, and a network side device, and belongs to the field of communication technologies. The multicast service processing method according to embodiments of this application includes: when a terminal joins a multicast service, if the terminal performs a first behavior, processing, by the terminal, a PDCP entity of an MRB of the multicast service according to target configuration information. The first behavior includes cell reselection or state switching, and the target configuration information includes first indication information. The first indication information is used for determining that state information of the PDCP entity is synchronized or not synchronized before and after the first behavior is performed.

### CROSS-REFERENCE TO RELATED APPLICATIONS

This application is a continuation of International Patent Application No. PCT/CN2024/086349, filed on Apr. 7, 2024, which claims priority to Chinese Patent Application No. 202310368580.9 filed in China on Apr. 7, 2023, both of which are incorporated herein by reference in their entireties.

### TECHNICAL FIELD

This application belongs to the field of communication technologies, and in particular, to a multicast service processing method and apparatus, a terminal, and a network side device.

### BACKGROUND

In a related technology, only a User Equipment (UE) is supported to receive a multicast service in a connected state.

### SUMMARY

Embodiments of this application provide a multicast service processing method and apparatus, a terminal, and a network side device.

According to a first aspect, a multicast service processing method is provided, where the method includes:
when a terminal joins a multicast service, if the terminal performs a first behavior, processing, by the terminal, a Packet Data Convergence Protocol (PDCP) entity of a multicast radio bearer (MBMS Radio Bearer, MRB) of the multicast service according to target configuration information.

The first behavior includes cell reselection or state switching, and the target configuration information includes at least one of the following: first configuration information, second configuration information, first indication information, quality of service QoS requirement information of the multicast service, or second indication information.

The first configuration information is configuration information of the MRB before the first behavior is performed, the second configuration information is configuration information of the MRB after the first behavior is performed, the first indication information is used for determining that state information of the PDCP entity is synchronized or not synchronized before and after the first behavior is performed, and the second indication information is used for indicating the terminal to process the PDCP entity after performing the first behavior.

According to a second aspect, a multicast service processing apparatus is provided, where the apparatus includes:
a first processing module, configured to: when a terminal joins a multicast service, if the terminal performs a first behavior, process a packet data convergence protocol PDCP entity of a multicast radio bearer MRB of the multicast service according to target configuration information.

The first behavior includes cell reselection or state switching, and the target configuration information includes at least one of the following: first configuration information, second configuration information, first indication information, quality of service QoS requirement information of the multicast service, or second indication information.

The first configuration information is configuration information of the MRB before the first behavior is performed, the second configuration information is configuration information of the MRB after the first behavior is performed, the first indication information is used for determining that state information of the PDCP entity is synchronized or not synchronized before and after the first behavior is performed, and the second indication information is used for indicating the terminal to process the PDCP entity after performing the first behavior.

According to a third aspect, a multicast service processing method is provided, where the method includes:

performing, by a network side device, a fourth operation when a terminal that joins a multicast service performs a first behavior.

The first behavior includes cell reselection or state switching, and the fourth operation includes at least one of the following:
configuring the terminal to synchronize state information of a packet data convergence protocol PDCP entity of a multicast radio bearer MRB of the multicast service before and after performing the first behavior; or
at least one of first indication information or second indication information, where the first indication information is used for determining that the state information of the PDCP entity is synchronized or not synchronized before and after the first behavior is performed, and the second indication information is used for indicating the terminal to process the PDCP entity after performing the first behavior.

According to a fourth aspect, a multicast service processing apparatus is provided, where the apparatus includes:
a first execution module, configured to perform a fourth operation when a terminal that joins a multicast service performs a first behavior.

The first behavior includes cell reselection or state switching, and the fourth operation includes at least one of the following:
configuring the terminal to synchronize state information of a packet data convergence protocol PDCP entity of a multicast radio bearer MRB of the multicast service before and after performing the first behavior; or
at least one of first indication information or second indication information, where the first indication information is used for determining that the state information of the PDCP entity is synchronized or not synchronized before and after the first behavior is performed, and the second indication information is used for indicating the terminal to process the PDCP entity after performing the first behavior.

According to a fifth aspect, a terminal is provided. The terminal includes a processor and a memory. The memory stores a program or instructions runnable on the processor, and the program or the instructions, when being executed by the processor, implement the steps of the method according to the first aspect.

According to a sixth aspect, a terminal is provided, including a processor and a communication interface. The processor is configured to: when a terminal joins a multicast service, if the terminal performs a first behavior, process a packet data convergence protocol PDCP entity of a multicast radio bearer MRB of the multicast service according to target configuration information. The first behavior includes cell reselection or state switching, and the target configuration information includes at least one of the following: first configuration information, second configuration information, first indication information, quality of service QoS requirement information of the multicast service, or second indication information. The first configuration information is configuration information of the MRB before the first behavior is performed, the second configuration information is configuration information of the MRB after the first behavior is performed, the first indication information is used for determining that state information of the PDCP entity is synchronized or not synchronized before and after the first behavior is performed, and the second indication information is used for indicating the terminal to process the PDCP entity after performing the first behavior.

According to a seventh aspect, a network side device is provided. The network side device includes a processor and a memory. The memory stores a program or instructions runnable on the processor, and the program or the instructions, when being executed by the processor, implement the steps of the method according to the third aspect.

According to an eighth aspect, a network side device is provided, including a processor and a communication interface. The processor is configured to perform a fourth operation when a terminal that joins a multicast service performs a first behavior. The first behavior includes cell reselection or state switching, and the fourth operation includes at least one of the following: configuring the terminal to synchronize state information of a packet data convergence protocol PDCP entity of a multicast radio bearer MRB of the multicast service before and after performing the first behavior; or at least one of first indication information or second indication information, where the first indication information is used for determining that the state information of the PDCP entity is synchronized or not synchronized before and after the first behavior is performed, and the second indication information is used for indicating the terminal to process the PDCP entity after performing the first behavior.

According to a ninth aspect, a multicast service processing system is provided, including a terminal and a network side device. The terminal is configured to perform the steps of the multicast service processing method according to the first aspect, and the network side device is configured to perform the steps of the multicast service processing method according to the third aspect.

According to a tenth aspect, a readable storage medium is provided. The readable storage medium stores a program or instructions, and the program or the instructions, when being executed by a processor, implement the steps of the method according to the first aspect, or implement the steps of the method according to the third aspect.

According to an eleventh aspect, a chip is provided. The chip includes a processor and a communication interface, the communication interface is coupled to the processor, and the processor is configured to run a program or instructions to implement the steps of the method according to the first aspect, or implement the steps of the method according to the third aspect.

According to a twelfth aspect, a computer program/program product is provided. The computer program/program product is stored in a storage medium, and the computer program/program product is executed by at least one processor, to implement the steps of the method according to the first aspect, or implement the steps of the method according to the third aspect.

### BRIEF DESCRIPTION OF THE DRAWINGS

FIG. 1 is a block diagram of a wireless communication system to which an embodiment of this application is applicable.

FIG. 2 is a flowchart of a multicast service processing method according to an embodiment of this application.

FIG. 3 is a flowchart of another multicast service processing method according to an embodiment of this application.

FIG. 4 is a structural diagram of a multicast service processing apparatus according to an embodiment of this application.

FIG. 5 is a structural diagram of another multicast service processing apparatus according to an embodiment of this application.

FIG. 6 is a structural diagram of a communication device according to an embodiment of this application.

FIG. 7 is a structural diagram of a terminal according to an embodiment of this application.

FIG. 8 is a structural diagram of a network side device according to an embodiment of this application.

### DETAILED DESCRIPTION

The technical solutions in the embodiments of this application are clearly described in the following with reference to the accompanying drawings in the embodiments of this application. Apparently, the described embodiments are some rather than all of the embodiments of this application. All other embodiments obtained by a person of ordinary skill in the art based on the embodiments of this application fall within the protection scope of this application.

The terms “first”, “second”, and so on are intended to distinguish between similar objects rather than describe a specific order. It should be understood that the terms used in such a way are interchangeable in appropriate circumstances, so that the embodiments of this application can be implemented in orders other than the order illustrated or described herein. In addition, the objects distinguished by “first” and “second” are usually of a same type, without limiting a quantity of objects, for example, there may be one or more first objects. In addition, in “or” used in this application represents at least one of the connected objects. For example, “A or B” covers three schemes, that is, solution 1: including A and excluding B; solution 2: including B and excluding A; and solution 3: including both A and B. The character “/” generally indicates an “or” relationship between the associated objects.

A term “indication” in this application may be a direct indication (or an explicit indication), or may be an indirect indication (or an implicit indication). The direct indication may be understood as that a sending party explicitly notifies a receiving party of content such as specific information, an operation that needs to be performed, or a request result in a sent indication. The indirect indication may be understood as that the receiving party determines corresponding information according to an indication sent by the sending party, or performs determining and determines an operation that needs to be performed or a request result according to a determining result.

It should be noted that the technologies described in the embodiments of this application are not limited to a Long Term Evolution (LTE)/LTE-Advanced (LTE-A) system, and can be further used in other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or other systems. The terms “system” and “network” in the embodiments of this application are often used interchangeably, and the described technologies can be used not only for the above-mentioned systems and radio technologies, but also for other systems and radio technologies. The following description describes a New Radio (NR) system for exemplary purposes, and uses NR terms in most of the following descriptions, but these technologies are also applicable to systems other than the NR system, such as a 6th Generation (6G) communication system.

When the UE is interested in a multicast service, a network side device needs to keep the UE in a connected state to receive the interested multicast service. This causes additional overheads of network side management and control, which is not beneficial to overall network efficiency. In addition, after the UE joins a multicast service, receiving of the multicast service is usually interrupted when state switching (for example, switching from a connected state to a non-connected state) or cell reselection is needed, causing poor continuity of reception of the multicast service.

Embodiments of this application provide a multicast service processing method and apparatus, a terminal, and a network side device, to improve continuity of reception of a multicast service when the terminal needs to perform state switching or cell reselection.

In the embodiments of this application, when a terminal joins a multicast service, if the terminal performs cell reselection or state switching, the terminal processes a PDCP entity of an MRB of the multicast service according to at least one of first configuration information, second configuration information, first indication information, QoS requirement information of the multicast service, or second indication information, and further may continue to receive the multicast service based on the PDCP entity of the MRB of the multicast service in a process of the cell reselection or state switching or after the cell reselection or state switching, to improve continuity of reception of the multicast service when the terminal needs to perform state switching or cell reselection.

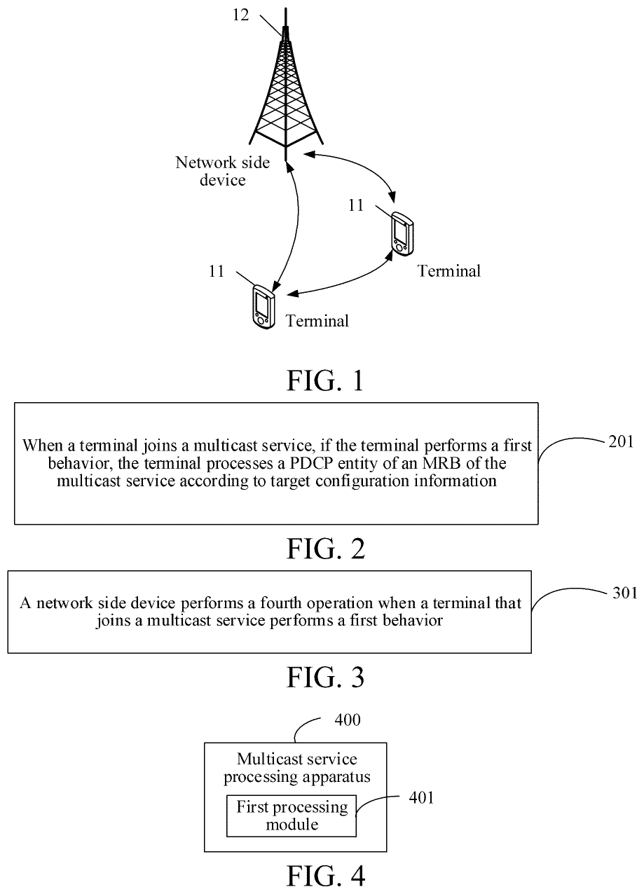

FIG. 1 is a block diagram of a wireless communication system to which an embodiment of this application is applicable. The wireless communication system includes a terminal 11 and a network side device 12. The terminal 11 may be a terminal side device such as a mobile phone, a tablet computer (Tablet Personal Computer), a laptop computer, a notebook computer, a Personal Digital Assistant (PDA), a palmtop computer, a netbook, an Ultra-mobile Personal Computer (UMPC), a Mobile Internet Device (MID), Augmented Reality (AR), a Virtual Reality (VR) device, a robot, a Wearable Device, a flight vehicle, a Vehicle User Equipment (VUE), a ship-borne equipment, a Pedestrian User Equipment (PUE), a smart household (a home device having a wireless communication function, for example, a refrigerator, a television, a washing machine, or furniture), a game console, a Personal Computer (PC), a teller machine, or a self-service machine. The wearable device includes: a smartwatch, a smart bracelet, a smart earphone, smart glasses, smart headwear (a smart bracelet, a smart bracelet, a smart ring, a smart necklace, a smart anklet, a smart anklet, and the like), a smart wristband, smart clothing, and the like. The vehicle-mounted device may also be referred to as a vehicle-mounted terminal, a vehicle-mounted controller, a vehicle-mounted module, a vehicle-mounted component, a vehicle-mounted chip, a vehicle-mounted unit, or the like. It should be noted that, a specific type of the terminal 11 is not limited in this embodiment of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (WiFi) node, and the like. The base station may be referred to as a Node B (NB), an Evolved Node B (eNB), a next generation Node B (gNB), a New Radio Node B (NR Node B), an access point, a relay station (Relay Base Station, RBS), a Serving Base Station (SBS), a Base Transceiver Station (BTS), a radio base station, a radio transceiver, a Basic Service Set (BSS), an Extended Service Set (ESS), a home Node B (HNB), a home evolved Node B, a Transmission Reception Point (TRP), or another suitable term in the field, provided that a same technical effect is achieved. The base station is not limited to a specific technical term. It should be noted that, in this embodiment of this application, only a base station in an NR system is used as an example for description, but the specific type of the base station is not limited.

The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a policy and charging rule function unit (Policy Control Function, PCF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF or L-NEF, a Binding Support Function (BSF), an Application Function (AF), and the like. It should be noted that, in this embodiment of this application, only a core network in an NR system is used as an example for description, but the specific type of the core network is not limited.

To facilitate understanding, the following explains content involved in the embodiments of this application.

### Broadcast and Multicast:

In broadcast/multicast transmission of LTE, sending of a multimedia broadcast multicast service in a Multicast Broadcast Single Frequency Network (MBSFN) manner and sending of a multicast service in a Single Cell Point to Multipoint (SC-PTM) manner are supported. In the MBSFN manner, a same broadcast service is sent synchronously in cells in a same MBSFN area, to facilitate receiving by a UE. Both control information (for example, a control channel parameter, a service channel parameter, or scheduling information) and data information of the MBMS service are sent in a broadcast manner, so that a UE in an IDLE state and in a connected state can receive the MBMS service. The SC-PTM is a multicast sending manner that is standardized after the MBMS service, and a largest difference between the SC-PTM and the MBSFN manner is that sending is scheduled only in a single cell, and service scheduling is performed by using a Group Radio Network Temporary Identity (G-RNTI). A control channel parameter, a service identifier, and periodicity information are broadcast in a broadcast message, the scheduling information is notified through a Physical Downlink Control Channel (PDCCH) scrambled by the G-RNTI, and a data part is sent in a multicast manner, which is equivalent to that a UE that is interested in the data monitors the G-RNTI to obtain data scheduling and receive the data.

When a Release 17th (R17) NR Broadcast service is received, a network includes indication information indicating whether the broadcast service is supported in a System Information Block (SIB) and a MultiCast Control Channel (MCCH). When performing cell reselection, a UE in an idle/Inactive state reselects to a target cell, and determines, depending on whether the target cell supports a service in which the UE is interested, that whether to read the MCCH or initiate establishment of a unicast to continue to receive the broadcast service.

Because only a UE in a Radio Resource Control (RRC) connected state is supported to receive an R17 NR Multicast service, there is no idle/inactive mobility problem. When the UE in the connected state moves and performs handover, interaction between a source cell and a target cell ensures that the target cell supports receiving of the multicast service in an appropriate manner, and a configuration of the target cell is sent to the UE by using dedicated signaling.

A multicast service processing method provided in the embodiments of this application is described in detail below with reference to the accompanying drawings by using some embodiments and application scenarios thereof.

Refer to FIG. 2. FIG. 2 is a flowchart of a multicast service processing method according to an embodiment of this application. The method may be performed by a terminal. As shown in FIG. 2, the method includes the following steps.

Step 201: When the terminal joins a multicast service, if the terminal performs a first behavior, the terminal processes a PDCP entity of an MRB of the multicast service according to target configuration information.

The first behavior includes cell reselection or state switching, and the target configuration information includes at least one of the following: first configuration information, second configuration information, first indication information, QoS requirement information of the multicast service, or second indication information.

The first configuration information is configuration information of the MRB before the first behavior is performed, the second configuration information is configuration information of the MRB after the first behavior is performed, the first indication information is used for determining that state information of the PDCP entity is synchronized or not synchronized before and after the first behavior is performed, and the second indication information is used for indicating the terminal to process the PDCP entity after performing the first behavior.

For example, when a UE is interested in a multicast service, the UE may initiate a join (Join) process to a network side device (for example, a core network) for the multicast service, to inform the core network, for example, an AMF, that the UE is interested in the multicast service and expects to receive the multicast service. Subsequently, when starting to send the multicast service, the network side device informs the UE to receive the multicast service.

The cell reselection is, for example, reselection from a source cell to a target cell. For example, when the UE receives a multicast service in a cell in a non-connected state, if the UE moves, the UE may reselect to another cell for receiving of the multicast service.

The state switching may include, but is not limited to, switching from a connected state to a non-connected state, or switching from the non-connected state to the connected state. The non-connected state may include, but is not limited to, an Idle state or an Inactive state.

Configuration information of the MRB may include at least one of configuration information of a Service Data Adaptation Protocol (SDAP) entity, configuration information of the PDCP entity, and the like.

The first configuration information is the configuration information of the MRB before the first behavior is performed. In other words, the first configuration information is used for configuring the MRB of the multicast service before the first behavior is performed. The second configuration information is the configuration information of the MRB after the first behavior is performed. In other words, the second configuration information is used for configuring the MRB of the multicast service after the first behavior is performed. For example, when the first behavior is the cell reselection from the source cell to the target cell, the first configuration information is a configuration of the MRB in the source cell, and the second configuration information is a configuration of the MRB in the target cell. When the first behavior is the state switching from the connected state to the non-connected state, the first configuration information is a configuration when the MRB is received in the connected state, and the second configuration information is a configuration when the MRB is received in the non-connected state. When the first behavior is the state switching from the non-connected state to the connected state, the first configuration information is a configuration when the MRB is received in the non-connected state, and the second configuration information is a configuration when the MRB is received in the connected state.

The state information of the PDCP entity may include, but is not limited to, a COUNT value, a Sequence Number (SN), or the like of the PDCP entity. For example, the first indication information may indicate that the COUNT value or the SN of the PDCP entity is synchronized or not synchronized.

The second indication information is used for indicating the terminal to process the PDCP entity after performing the first behavior. For example, the second indication information is used for indicating the terminal to maintain a current state of the PDCP entity after performing the first behavior, or the second indication information is used for indicating the terminal to re-establish or reset the PDCP entity after performing the first behavior.

The QoS requirement information may include at least one of block error rate requirement information, delay requirement information, and the like. For example, when the QoS requirement information indicates at least one of the following: a block error rate requirement is not high (for example, a block error rate indicator is high than or is not less than a preset threshold) or a delay requirement is relatively high, the PDCP entity of the MRB may be re-established. For example, the preset threshold may be 10⁻⁴.

This embodiment of this application may be described by using an example in the following cases.

### Case 1: The Target Configuration Information Includes the First Configuration Information and the Second Configuration Information.

For example, the terminal may determine, by comparing the first configuration information and the second configuration information, whether the COUNT value or the SN of the PDCP entity is synchronized before and after performing the first behavior, and when the COUNT value or the SN of the PDCP entity is synchronized before and after performing the first behavior, maintain a current state of the PDCP entity, or when the COUNT value or the SN of the PDCP entity is not synchronized before and after performing the first behavior, re-establish or reset the PDCP entity.

For another example, when the first behavior is the cell reselection from the source cell to the target cell, the terminal may determine, by comparing the first configuration information and the second configuration information, whether a mapping from a QoS flow for the multicast service to an MRB in the source cell is the same as a mapping from a QoS flow for the multicast service to an MRB in the target cell, and when the mapping from the QoS flow for the multicast service to the MRB in the source cell is the same as the mapping from the QoS flow for the multicast service to the MRB in the target cell, maintain a current state of the PDCP entity, or when the mapping from the QoS flow for the multicast service to the MRB in the source cell is not the same as the mapping from the QoS flow for the multicast service to the MRB in the target cell, re-establish or reset the PDCP entity.

### Case 2: The Target Configuration Information Includes the First Indication Information.

For example, when the first indication information indicates that the state information of the PDCP entity is synchronized before and after the first behavior is performed, the terminal maintains a current state of the PDCP entity, or when the first indication information indicates that the state information of the PDCP entity is not synchronized before and after the first behavior is performed, the terminal re-establishes or resets the PDCP entity.

### Case 3: The Target Configuration Information Includes the QoS Requirement Information.

For example, when the first behavior is the cell reselection from the source cell to the target cell, the terminal may determine, according to the QoS requirement information, whether a state variable that is of the PDCP entity and that corresponds to the source cell can be continuously used in the target cell. If the state variable that is of the PDCP entity and that corresponds to the source cell can be continuously used in the target cell, the terminal maintains a current state of the PDCP entity. If the state variable that is of the PDCP entity and that corresponds to the source cell cannot be continuously used in the target cell, the terminal re-establishes or resets the PDCP entity.

It may be understood that, the types of information (namely, the first configuration information, the second configuration information, the first indication information, the QoS requirement information, and the second indication information) may be properly combined according to a requirement. For example, when the target configuration information includes the first indication information and the QoS requirement information, if the first indication information indicates that the state information of the PDCP entity is synchronized before and after the first behavior is performed, and the QoS requirement information meets a preset condition (for example, the delay requirement is relatively low), the terminal maintains the current state of the PDCP entity. If the first indication information indicates that the state information of the PDCP entity is synchronized before and after the first behavior is performed, and the QoS requirement information does not meet the preset condition (for example, the delay requirement is relatively high), the terminal re-establishes or resets the PDCP entity. If the first indication information indicates that the state information of the PDCP entity is not synchronized before and after the first behavior is performed, the terminal may re-establish or reset the PDCP entity regardless of whether the QoS requirement information meets the preset condition.

It should be further noted that the resetting the PDCP entity is, for example, initializing the state variable of the PDCP entity. The maintaining, by the terminal, the current state of the PDCP entity may include, for example, maintaining a state variable value of the PDCP entity. The state variable of the PDCP entity may include at least one of a reception variable for delivery to a high layer (namely, RX_DELIV), a next reception variable (namely, RX_NEXT), or a reordering reception variable (namely, RX_REORD).

According to the multicast service processing method provided in this embodiment of this application, when a terminal joins a multicast service, if the terminal performs cell reselection or state switching, the terminal processes a PDCP entity of an MRB of the multicast service according to at least one of first configuration information, second configuration information, first indication information, QoS requirement information of the multicast service, or second indication information, and further may continue to receive the multicast service based on the PDCP entity of the MRB of the multicast service in a process of the cell reselection or state switching or after the cell reselection or state switching, to improve continuity of reception of the multicast service when the terminal needs to perform state switching or cell reselection.

Optionally, the processing, by the terminal, a PDCP entity of an MRB of the multicast service according to target configuration information includes:
when determining, according to the target configuration information, that a count COUNT value or a sequence number SN of the PDCP entity is synchronized before and after performing the first behavior, maintaining, by the terminal, a current state of the PDCP entity of the MRB;
or
when determining, according to the target configuration information, that a COUNT value or an SN of the PDCP entity is not synchronized before and after performing the first behavior, re-establishing or resetting, by the terminal, the PDCP entity of the MRB.

For example, when the target configuration information includes the first configuration information and the second configuration information, the terminal may determine, by comparing the first configuration information and the second configuration information, whether the COUNT value or the SN of the PDCP entity is synchronized before and after performing the first behavior. When the target configuration information includes the first indication information, the terminal may determine, based on the first indication information, whether the COUNT value or the SN of the PDCP entity is synchronized before and after performing the first behavior. For example, if the first indication information is used for indicating that the COUNT value or the SN of the PDCP entity is synchronized before and after the first behavior is performed, the terminal determines that the COUNT value or the SN of the PDCP entity is synchronized before and after performing the first behavior. If the first indication information is used for indicating that the COUNT value or the SN of the PDCP entity is not synchronized before and after the first behavior is performed, the terminal determines that the COUNT value or the SN of the PDCP entity is not synchronized before and after performing the first behavior.

That the COUNT value or the SN of the PDCP entity is synchronized before and after the first behavior is performed is described below in different cases:

Case 1: The First Behavior is the Cell Reselection from the Source Cell to the Target Cell.

When the terminal determines that the source cell is synchronized with the target cell with respect to the COUNT value or the SN of the PDCP entity of the MRB, the terminal may directly receive data of the MRB in the target cell, maintain a current receiving state of the PDCP entity and continue to receive the data, sort and repeatedly detect received data in the source cell and received data in the target cell according to the synchronized PDCP COUNT value, and finally send a data packet to a high layer in ascending order of the PDCP COUNT value to complete continuous reception. In other words, any additional operation, for example, re-establishment or resetting, does not need to be performed on the PDCP entity, and after the cell reselection, the current receiving action is directly continued, and the multicast service continues to be received.

Case 2: The First Behavior is the State Switching from the Connected State to the Non-Connected State.

When the terminal determines that the COUNT value or the SN of the PDCP entity of the MRB is synchronized in the connected state and the non-connected state, after being released from the connected state, the terminal may directly receive data of the MRB in the non-connected state, maintain a current receiving state of the PDCP entity and continue to receive the data, sort and repeatedly detect received data in the connected state and received data in the non-connected state according to the synchronized PDCP COUNT value, and finally send a data packet to a high layer in ascending order of the PDCP COUNT value to complete continuous reception. In other words, any additional operation, for example, re-establishment or resetting, does not need to be performed on the PDCP entity, and after the state switching, the current receiving action is continued, and continuous reception is performed.

In some optional embodiments, after being released back to a non-connected state, for a Media Access Control (MAC) entity related to an MRB, a Radio Link Control (RLC) entity, a timer of the PDCP entity, a state variable, a Hybrid Automatic Repeat Request (HARQ) process, or the like, a UE maintains a current state for continuous execution without resetting (reset) or re-establishment. In addition, after being released back to the non-connected state, the UE may immediately read a multicast configuration on a MultiCast Control Channel (MCCH), and may immediately use the multicast configuration, including Discontinuous Reception (DRX), and the like.

Case 3: The First Behavior is the State Switching from the Non-Connected State to the Connected State.

When the terminal determines that the COUNT value or the SN of the PDCP entity of the MRB is synchronized in the connected state and the non-connected state, the terminal may directly receive data of the MRB in the connected state, maintain a current receiving state of the PDCP entity and continue to receive the data, sort and repeatedly detect received data in the non-connected state and received data in the connected state according to the synchronized PDCP COUNT value, and finally send a data packet to a high layer in ascending order of the PDCP COUNT value to complete continuous reception. In other words, any additional operation, for example, reestablishment or resetting, does not need to be performed on the PDCP entity, and after the state switching, the current receiving action is continued, and continuous reception is performed.

In some optional embodiments, after returning from the non-connected state to the connected state, for a MAC entity related to an MRB, an RLC entity, a timer of the PDCP entity, a state variable, a HARQ process, or the like, the terminal may maintain a current state for continuous execution without a resetting or re-establishment operation.

In some optional embodiments, in this case, a center of a bandwidth of the multicast service is aligned with and partially overlaps with a center of a bandwidth used for initial access, to ensure that the terminal can simultaneously transmit a Random Access Channel (RACH) and receive the multicast service.

It should be noted that, after the terminal returns from the non-connected state to the connected state, a network side may alternatively re-establish or reset the PDCP entity of the terminal or release and add (namely, release+add) the PDCP entity of the terminal according to a requirement, and resend a PDCP COUNT initial value to the UE, so that the UE can update the receiving state in the non-connected state. Timers, states, HARQ processes, and the like related to the MRB in a corresponding RLC and MAC can all be reset and restarted.

In this embodiment, when determining, according to the target configuration information, that the count COUNT value or the sequence number SN of the PDCP entity is synchronized before and after performing the first behavior, the terminal maintains the current state of the PDCP entity of the MRB, when determining, according to the target configuration information, that the COUNT value or the SN of the PDCP entity is not synchronized before and after performing the first behavior, the terminal re-establishes or resets the PDCP entity of the MRB. This is beneficial to improve continuity of reception of the multicast service when the terminal performs the first behavior.

During actual application, when a terminal receives a multicast service in a non-connected state, the terminal may obtain configuration information of the multicast service from dedicated signaling or common signaling (for example, a multicast MCCH). When moving, the terminal may reselect to another target cell. If the target cell also supports receiving of the multicast service in the non-connected state, after reselecting to the target cell, the terminal may obtain, by reading a multicast MCCH of the target cell, a configuration of the multicast service that is being received by the terminal, to continue to receive the service in the target cell. However, in a process in which the terminal reselects from a source cell to the target cell, if the terminal needs to continuously and losslessly receive the service in the target cell, the source cell needs to be synchronized with the target cell with respect to a PDCP COUNT value of a same MRB, that is, a same PDCP COUNT/SN value is allocated to a same data packet. The terminal may directly perform functions such as reordering and repeated detection according to the PDCP SN/COUNT value from the two cells, to achieve a continuous receiving effect of sequentially delivering a service data packet to a high layer. Based on this, an embodiment of this application provides the following manner of determining whether the COUNT value or the SN of the PDCP entity is synchronized between the source cell and the target cell.

Optionally, the first behavior is the cell reselection from a source cell to a target cell, and the target configuration information includes the first indication information.

The first indication information is used for indicating at least one of the following:
the COUNT value or the SN of the PDCP entity is synchronized or not synchronized between the source cell and the target cell;
at least one first cell, where each first cell is synchronized with the source cell with respect to a COUNT value or an SN of a PDCP entity of a same MRB; or
at least one second cell, where each second cell is synchronized with the target cell with respect to the COUNT value or the SN of the PDCP entity of the same MRB.

In an implementation, the first indication information may directly indicate that the COUNT value or the SN of the PDCP entity is synchronized or not synchronized between the source cell and the target cell. In this way, the terminal quickly learns, based on the first indication information, whether the COUNT value or the SN of the PDCP entity is synchronized between the source cell and the target cell.

In another implementation, the first indication information may indicate the at least one first cell that is synchronized with the source cell with respect to the COUNT value or the SN of the PDCP entity of the same MRB, where the first cell may be a neighboring cell of the source cell. In this way, the terminal may determine, by determining whether the target cell is a cell in the at least one first cell, whether the COUNT value or the SN of the PDCP entity is synchronized between the source cell and the target cell. For example, when the target cell is the cell in the at least one first cell, the terminal determines that the COUNT value or the SN of the PDCP entity is synchronized between the source cell and the target cell. When the target cell is not the cell in the at least one first cell, the terminal determines that the COUNT value or the SN of the PDCP entity is not synchronized between the source cell and the target cell.

In some optional embodiments, an indication granularity of the at least one first cell may be one of the following: each terminal, each multicast service, and each MRB. That the indication granularity is each terminal may be understood as that the at least one first cell is effective for all multicast services of the terminal. That the indication granularity is each multicast service may be understood as that the at least one first cell is effective for only a single multicast service. That the indication granularity is each MRB may be understood as that the at least one first cell is effective for only a single MRB.

For example, the source cell carries a neighboring cell list whose PDCP COUNT value is synchronized with a PDCP COUNT value of the source cell. The neighboring cell list may be effective for all multicast services, may be effective for a single multicast service (that is, may be indicated for each multicast service), or may be effective for a single MRB (that is, may be indicated for each MRB of each multicast service). It may be understood that a coarser indication granularity indicates lower flexibility but lower overheads, and a finer indication granularity indicates higher flexibility but higher overheads.

In still another implementation, the first indication information may indicate the at least one second cell that is synchronized with the target cell with respect to the COUNT value or the SN of the PDCP entity of the same MRB, where the second cell may be a neighboring cell of the target cell. In this way, the terminal may determine, by determining whether the source cell is a cell in the at least one second cell, whether the COUNT value or the SN of the PDCP entity is synchronized between the source cell and the target cell. For example, when the source cell is the cell in the at least one second cell, the terminal determines that the COUNT value or the SN of the PDCP entity is synchronized between the source cell and the target cell. When the source cell is not the cell in the at least one second cell, the terminal determines that the COUNT value or the SN of the PDCP entity is not synchronized between the source cell and the target cell.

In some optional embodiments, an indication granularity of the at least one second cell may be one of the following: each terminal, each multicast service, and each MRB.

It should be noted that, the same MRB is an MRB of a same multicast service. In addition, the same MRB may be understood as an MRB carrying same content, for example, an MRB to which a same multicast QoS flow is mapped.

It should be noted that, if a UE can obtain COUNT synchronization information (namely, the neighboring cell list whose PDCP COUNT value is synchronized) in the source cell, the UE may prepare a subsequent operation before reselection, so that performance is relatively good. If there is no COUNT synchronization information in the source cell, the UE can obtain the COUNT synchronization information only by reselecting to the target cell, and can determine a subsequent operation according to the COUNT synchronization information only after the reselection, resulting in a relatively poor delay. However, generally, if COUNT synchronization information of a neighboring cell is introduced, multicast service cells including the source cell and the target cell broadcasts the COUNT synchronization information by using common signaling, to facilitate use by the UE.

Optionally, the first behavior is the cell reselection from a source cell to a target cell, and the target configuration information includes the first configuration information and the second configuration information.

The first configuration information includes a mapping from a QoS flow for the multicast service to an MRB in the source cell, and the second configuration information includes a mapping from a QoS flow for the multicast service to an MRB in the target cell.

In this embodiment, the terminal may determine processing on the PDCP entity by comparing whether the mapping from the QoS flow for the multicast service to the MRB in the source cell is the same as the mapping from the QoS flow for the multicast service to the MRB in the target cell. For example, when the mapping from the QoS flow for the multicast service to the MRB in the source cell is the same as the mapping from the QoS flow for the multicast service to the MRB in the target cell, the terminal maintains the current state of the PDCP entity of the MRB. When the mapping from the QoS flow for the multicast service to the MRB in the source cell is not the same as the mapping from the QoS flow for the multicast service to the MRB in the target cell, the terminal re-establishes or resets the PDCP entity of the MRB.

It should be noted that, if the mapping from the QoS flow for the multicast service to the MRB in the source cell is the same as the mapping from the QoS flow for the multicast service to the MRB in the target cell, it may be determined that the COUNT value or the SN of the PDCP entity is synchronized between the source cell and the target cell. If the mapping from the QoS flow for the multicast service to the MRB in the source cell is not the same as the mapping from the QoS flow for the multicast service to the MRB in the target cell, it may be determined that the COUNT value or the SN of the PDCP entity is not synchronized between the source cell and the target cell.

For example, an MRB 1 of the source cell includes a QoS flow 1, a QoS flow 2, and a QoS flow 3 for a Temporary Mobile Group Identity (TMGI) 1 service, an MRB 1 of the target cell also includes the QoS flow 1, the QoS flow 2, and the QoS flow 3 for the TMGI 1 service, and mappings are identical. In this case, both PDCP COUNT values of the MRB 1 of the two cells are from a QoS flow SN in a data pipeline from a Core Network (CN) to a base station (namely, gNB), and the SN in the pipeline is sent to different gNBs by a same CN node and is synchronized. Therefore, the PDCP COUNT values of the MRB of the two cells are synchronized.

Correspondingly, if the MRB 1 of the source cell includes the QoS flow 1, the QoS flow 2, and the QoS flow 3 for the TMGI 1 service, the MRB 1 of the target cell includes the QoS flow 1 and the QoS flow 2 for the TMGI 1 service, and the mappings are not identical, both the PDCP COUNT values of the MRB 1 of the two cells are from the QoS flow SN in the data pipeline from the CN to the gNB, and although the SN in the pipeline are synchronized, QoS flow combinations are different. Therefore, the PDCP COUNT values of the MRB of the two cells are not synchronized.

In this embodiment, it is implicitly determined, based on the mapping from the QoS flow for the multicast service to the MRB in the source cell and the mapping from the QoS flow for the multicast service to the MRB in the target cell, whether the COUNT value or the SN of the PDCP entity is synchronized between the source cell and the target cell, to reduce resource overheads.

Optionally, the first behavior is the cell reselection from the source cell to the target cell; and
the processing, by the terminal, a PDCP entity of an MRB of the multicast service according to target configuration information includes:
when determining, according to the target configuration information, that a state variable that is of the PDCP entity and that corresponds to the source cell cannot be used in the target cell, re-establishing or resetting, by the terminal after reselecting to the target cell, the PDCP entity of the MRB;
or
when determining, according to the target configuration information, that a state variable that is of the PDCP entity and that corresponds to the source cell cannot be used in the target cell, switching, by the terminal after reselecting to the target cell, from a non-connected state to a connected state, and re-establishing the PDCP entity of the MRB or processing the PDCP entity of the MRB of the multicast service according to indication information received from a network side device.

In this embodiment, the state variable that is of the PDCP entity and that corresponds to the source cell may be understood as a state variable of a PDCP entity used in the source cell. The state variable may include, but is not limited to, at least one of a reception variable for delivery to a high layer (namely, RX_DELIV), a next reception variable (namely, RX_NEXT), a reordering reception variable (namely, RX_REORD), and the like. The state variable that is of the PDCP entity and that corresponds to the source cell cannot be used in the target cell, that is, the state variable of the PDCP entity of the MRB needs to be re-established in the target cell.

For example, when the source cell is not synchronized with the target cell with respect to the COUNT value or the SN of the PDCP entity of the MRB, it may be determined that the state variable that is of the PDCP entity and that corresponds to the source cell cannot continue to be used in the target cell. When the source cell is synchronized with the target cell with respect to the COUNT value or the SN of the PDCP entity of the MRB, it may be further determined, based on the QoS requirement information, whether the state variable that is of the PDCP entity and that corresponds to the source cell can continue to be used in the target cell. For example, when the QoS requirement information indicates at least one of the following: the block error rate requirement is not high or the delay requirement is relatively high, it may be determined that the state variable that is of the PDCP entity and that corresponds to the source cell cannot continue to be used in the target cell. In this way, the terminal can quickly establish a new reception initialization variable in the target cell, to avoid a waiting delay caused by a delay gap in sent data between the source cell and the target cell, so as to facilitate faster restoration of data reception in the target cell.

In an implementation, when determining, according to the target configuration information, that the state variable that is of the PDCP entity and that corresponds to the source cell cannot be used in the target cell, the terminal re-establishes or resets, after the terminal reselects to the target cell, the PDCP entity of the MRB. This is beneficial to rapidly restore data reception in the target cell.

In another implementation, when determining, according to the target configuration information, that the state variable that is of the PDCP entity and that corresponds to the source cell cannot be used in the target cell, the terminal may directly trigger the connected state after reselecting to the target cell, and re-establish the PDCP entity, or the terminal may determine, based on the indication information of the network side device, to re-establish the PDCP entity or maintain the current state of the PDCP entity.

It may be understood that when the terminal enters the connected state, the network side device may send, based on dedicated signaling, an initial COUNT value of the PDCP entity of the MRB to the terminal. In this way, after re-establishing the PDCP entity, the terminal may assign the initial COUNT value to RX_DELIV, to start service reception in the target cell.

It should be further noted that when determining, according to the target configuration information, the state variable that is of the PDCP entity and that corresponds to the source cell can be used in the target cell, the terminal may maintain the current state of the PDCP entity, to ensure continuous reception of the multicast service.

Optionally, after the re-establishing or resetting, by the terminal after reselecting to the target cell, the PDCP entity of the MRB, or after the switching, by the terminal after reselecting to the target cell, from a non-connected state to a connected state, and re-establishing the PDCP entity of the MRB or processing the PDCP entity of the MRB of the multicast service according to indication information received from a network side device, the method further includes:
setting, by the terminal, an initial value of the state variable of the PDCP entity according to a PDCP SN of a 1^{st} data packet received in the target cell;
or
receiving, by the terminal, a first state variable value, and setting an initial value of the state variable of the PDCP entity based on the first state variable value.

In an implementation, after reselecting to the target cell, the terminal re-establishes or resets the PDCP entity of the MRB, and restores all state variables to initial values, for example, a corresponding COUNT or SN variable value is 0. In addition, the initial value of the state variable of the PDCP entity may be set according to the PDCP SN of the 1^{st} data packet received in the target cell. For example, an SN part of RX_NEXT is set to the SN of the 1^{st} data packet plus one, modulo an SN space size, that is, (first SN+1) modulo 2[PDCP-SN-SizeDL]. The first SN represents the SN of the 1^{st} data packet, modulo represents modulo calculation, 2[PDCP-SN-SizeDL] represents the SN space size, PDCP-SN-SizeDL represents a length of a downlink PDCP SN. A set value of a Hyper Frame Number (HFN) part of RX_NEXT may be implemented based on the terminal. An SN part of the variable RX_DELIV may be set to the SN of the 1^{st} data packet minus 0.5 multiplied by a receive window size, modulo the SN space size, that is, (first SN−0.5×2[PDCPs-SN-SizeDLs−1]) modulo (2[PDCPs-SN-SizeDLs]). The first SN represents the SN of the 1^{st} data packet, 2[PDCPs-SN-SizeDLs−1] represents the receive window size, 2[PDCPs-SN-SizeDLs] represents the SN space size, and PDCP-SN-SizeDL represents a length of a downlink PDCP SN. A set value of an HFN part of RX_DELIV may also be implemented based on the UE. It should be noted that the set value of the HFN part of RX_DELIV is related to the set value of the HFN part of RX_NEXT.

In another implementation, the first state variable value may be received from the network side device, and the initial value of the state variable of the PDCP entity may be set according to the first state variable value. Optionally, the first state variable value may include a suggested COUNT value or a suggested HFN value.

Optionally, the first state variable value is carried in a multicast control channel MCCH of the target cell or carried in dedicated signaling. In other words, the network side device may send the first state variable value based on the multicast control channel MCCH of the target cell, or may send the first state variable value to the terminal by using the dedicated signaling.

An example in which the first state variable value is carried in the MCCH of the target cell is used. The network side device may perform MCCH modification according to a requirement at an initial location of each modification period of the MCCH for the multicast service, carry a latest COUNT value or a COUNT value plus one (namely, the suggested COUNT value) of a PDCP PDU currently sent by the network side device, or carry an HFN value (namely, the suggested HFN value) corresponding to the latest COUNT value of the PDCP Protocol Data Unit (PDU) currently sent by the network side device, and repeatedly send the first state variable value according to an MCCH repetition period in the entire modification period, so that a new UE reselecting to the target cell can receive the first state variable value.

It should be noted that, when the first state variable value includes the suggested COUNT value, the new UE reselecting to the target cell can obtain the initial value of the state variable of the PDCP entity in time. For example, the UE may directly set RX_DELIV to the COUNT value or the COUNT value plus one, and then may normally receive data in the target cell. However, because each data packet corresponds to a COUNT value, when data is relatively dense, a COUNT initial value may need to be updated in each MCCH modification period. In this way, all UEs reselecting to the target cell need to receive the MCCH of the target cell to determine whether to update the COUNT initial value. This easily causes unnecessary resource consumption for some UEs.

When the first state variable value includes the suggested HFN value, the new UE reselecting to the target cell may set the initial value of the state variable of the PDCP entity in time according to the suggested HFN value. For example, the UE may set the SN part of RX_NEXT to the SN of the 1^{st} data packet plus one, modulo the SN space size, that is, (first SN+1) modulo 2[PDCPs-SN-SizeDLs]. The set value of the HFN part of RX_NEXT is equal to an HFN value or the HFN value plus one carried in the MCCH. The SN part of the variable RX_DELIV is set to the SN of the 1^{st} data packet minus 0.5 multiplied by the receive window size, modulo the SN space size, that is, (first SN−0.5×2)[PDCPs-SN-SizeDLs−1]) modulo (2[PDCPs-SN-SizeDLs]). The set value of the HFN part of RX_DELIV may also be set based on the HFN value carried in the MCCH. For example, the set value of the HFN part of RX_DELIV is equal to the HFN value, the HFN value plus one, or the HFN value minus 1. Because the HFN value is a high-order bit of the COUNT value, when a length of the SN is 18, the HFN value is increased by 1 only after 218 data packets are sent. Therefore, updating of the HFN value is relatively slow, so that smaller impact is caused on the MCCH modification period in comparison with a manner of carrying the COUNT value.

Optionally, the first behavior is the state switching, and the state switching is switching from a non-connected state to a connected state; and
the processing, by the terminal, a PDCP entity of an MRB of the multicast service according to target configuration information includes:
when determining, according to the target configuration information, that a COUNT value or a sequence number SN of the PDCP entity is synchronized or not synchronized before and after performing state switching, performing, by the terminal, one of the following:
after being switched from the non-connected state to the connected state, re-establishing or resetting the PDCP entity of the MRB; and
after being switched from the non-connected state to the connected state, processing the PDCP entity of the MRB of the multicast service according to indication information received from a network side device.

In an implementation, when determining, according to the target configuration information, that the COUNT value or the sequence number SN of the PDCP entity is synchronized or not synchronized before and after performing state switching, the terminal may directly re-establish or reset the PDCP entity of the MRB after being switched from the non-connected state to the connected state, and set the initial value of the state variable of the PDCP entity based on a state variable value (for example, the COUNT value or the HFN value) sent by the network side device by using the dedicated signaling.

In another implementation, when determining, according to the target configuration information, that the COUNT value or the sequence number SN of the PDCP entity is synchronized or not synchronized before and after performing state switching, the terminal may determine to process the PDCP entity of the MRB of the multicast service based on an indication of the network side device after being switched from the non-connected state to the connected state. For example, if the network side device indicates to maintain the current state of the PDCP entity of the MRB, the terminal maintains the current state of the PDCP entity of the MRB. If the network side device indicates to re-establish or reset the PDCP entity of the MRB, the terminal re-establishes or resets the PDCP entity of the MRB, and may set the initial value of the state variable of the PDCP entity based on a state variable value (for example, the COUNT value or the HFN value) sent by the network side device by using the dedicated signaling.

Optionally, the method further includes:
performing, by the terminal, a first operation when the first behavior is the state switching, and the terminal maintains the current state of the PDCP entity of the MRB, where the first operation includes at least one of the following: maintaining a current state of a radio link control RLC entity of the MRB, or maintaining a state and an operation that are related to the multicast service and that are of a media access control MAC entity of the MRB;
or
performing, by the terminal, a second operation when the first behavior is the cell reselection, and the terminal maintains the current state of the PDCP entity of the MRB, where the second operation includes at least one of the following: re-establishing or resetting an RLC entity of the MRB, or resetting a state and an operation that are related to the multicast service and that are of a MAC entity of the MRB;
or
performing, by the terminal, a third operation when the terminal re-establishes or resets the PDCP entity of the MRB, where the third operation includes at least one of the following: re-establishing or resetting an RLC entity of the MRB, or resetting a state and an operation that are related to the multicast service and that are of a MAC entity of the MRB.

The terminal resets the RLC entity, for example, initializes a state variable of the RLC entity. The terminal maintains a current state of the RLC entity, for example, maintains a state variable value of the RLC entity.

The terminal resets the state and the operation that are related to the multicast service and that are of the MAC entity, for example, resets a timer and a HARQ process. However, this manner causes a failure of the HARQ process, resulting in a data loss, which is not beneficial to service continuity. The terminal maintains the state and the operation that are related to the multicast service and that are of the MAC entity. For example, the terminal may maintain a current operation and state of the timer and the HARQ process, and continue to perform an operation. If a length of the timer is reconfigured, a new configuration parameter may be applied to a newly started timer after the current timer ends, thereby facilitating service continuity.

It can be learned based on the foregoing that this embodiment of this application provides a continuous receiving method during state switching and cell reselection of a UE that receives a multicast service in a non-connected state, so that the terminal can obtain service configuration information and COUNT information in time during switching from a non-connected state to a connected state or during cell reselection in the non-connected state, to continuously receive a service, thereby ensuring continuity of reception of a multicast service, and improving UE experience and system efficiency while ensuring a receiving effect.

Refer to FIG. 3. FIG. 3 is a flowchart of a multicast service processing method according to an embodiment of this application. The method may be performed by a network side device. As shown in FIG. 3, the method includes the following steps.

Step 301: The network side device performs a fourth operation when a terminal that joins a multicast service performs a first behavior.

The first behavior includes cell reselection or state switching, and the fourth operation includes at least one of the following:
configuring the terminal to synchronize state information of a packet data convergence protocol PDCP entity of a multicast radio bearer MRB of the multicast service before and after performing the first behavior; or
at least one of first indication information or second indication information, where the first indication information is used for determining that the state information of the PDCP entity is synchronized or not synchronized before and after the first behavior is performed, and the second indication information is used for indicating the terminal to process the PDCP entity after performing the first behavior.

In an implementation, the network side device may configure the terminal to synchronize the state information of the packet data convergence protocol PDCP entity of the multicast radio bearer MRB of the multicast service before and after performing the first behavior. In this way, after performing the first behavior, the terminal may maintain a current state of the PDCP entity of the MRB of the multicast service, to ensure continuity of reception of the multicast service.

In another implementation, the network side device may send at least one of the first indication information or the second indication information to the terminal based on a configuration case of a same MRB of a same multicast service of the terminal before and after the terminal performs the first behavior. In this way, the terminal may process the PDCP entity of the MRB of the multicast service based on at least one of the first indication information or the second indication information.

Optionally, the state switching is switching from a connected state to a non-connected state, or the state switching is switching from the non-connected state to the connected state.

Optionally, the configuring the terminal to synchronize state information of a packet data convergence protocol PDCP entity of a multicast radio bearer MRB of the multicast service before and after performing the first behavior includes:
configuring the terminal to synchronize a COUNT value or an SN of the PDCP entity of the MRB of the multicast service before and after performing the first behavior;
or
configuring mappings from a QoS flow for the multicast service to an MRB in a source cell and a target cell to be the same, where the first behavior is cell reselection from the source cell to the target cell.

Optionally, the first behavior is the cell reselection from the source cell to the target cell, and the first indication information is used for indicating at least one of the following:
the COUNT value or the SN of the PDCP entity is synchronized or not synchronized between the source cell and the target cell;
at least one first cell, where each first cell is synchronized with the source cell with respect to a COUNT value or an SN of a PDCP entity of a same MRB; or
at least one second cell, where each second cell is synchronized with the target cell with respect to the COUNT value or the SN of the PDCP entity of the same MRB.

Optionally, the first behavior is the cell reselection from the source cell to the target cell; and the method further includes:
sending, by the network side device, a first state variable value, wherein the first state variable value is used for setting an initial value of a state variable of the PDCP entity after the terminal reselects to the target cell.

Optionally, the first state variable value is carried in a multicast control channel MCCH of the target cell or carried in dedicated signaling.

Optionally, the first state variable value includes a suggested COUNT value or a suggested hyper frame number HFN value.

It should be noted that, for an implementation of the implementation, refer to the related descriptions in the embodiment shown in FIG. 2. Details are not described herein again.

It should be noted that, the multicast service processing method provided in the embodiments of this application may be performed by a multicast service processing apparatus or a control module configured to perform the multicast service processing method in the multicast service processing apparatus. In the embodiments of this application, an example in which the multicast service processing apparatus performs the multicast service processing method is used to describe the multicast service processing apparatus according to the embodiments of this application.

Refer to FIG. 4. FIG. 4 is a structural diagram of a multicast service processing apparatus according to an embodiment of this application. As shown in FIG. 4, the multicast service processing apparatus 400 includes:
a first processing module 401, configured to: when a terminal joins a multicast service, if the terminal performs a first behavior, process a packet data convergence protocol PDCP entity of a multicast radio bearer MRB of the multicast service according to target configuration information.

The first behavior includes cell reselection or state switching, and the target configuration information includes at least one of the following: first configuration information, second configuration information, first indication information, quality of service QoS requirement information of the multicast service, or second indication information.

The first configuration information is configuration information of the MRB before the first behavior is performed, the second configuration information is configuration information of the MRB after the first behavior is performed, the first indication information is used for determining that state information of the PDCP entity is synchronized or not synchronized before and after the first behavior is performed, and the second indication information is used for indicating the terminal to process the PDCP entity after performing the first behavior.

Optionally, the state switching is switching from a connected state to a non-connected state, or the state switching is switching from the non-connected state to the connected state.

Optionally, the first processing module is specifically configured to:
when determining, according to the target configuration information, that a count COUNT value or a sequence number SN of the PDCP entity is synchronized before and after performing the first behavior, maintain a current state of the PDCP entity of the MRB;
or
when determining, according to the target configuration information, that a COUNT value or an SN of the PDCP entity is not synchronized before and after performing the first behavior, re-establish or reset the PDCP entity of the MRB.

Optionally, the first behavior is the cell reselection from a source cell to a target cell, and the target configuration information includes the first indication information.

The first indication information is used for indicating at least one of the following:
the COUNT value or the SN of the PDCP entity is synchronized or not synchronized between the source cell and the target cell;
at least one first cell, where each first cell is synchronized with the source cell with respect to a COUNT value or an SN of a PDCP entity of a same MRB; or
at least one second cell, where each second cell is synchronized with the target cell with respect to the COUNT value or the SN of the PDCP entity of the same MRB.

Optionally, the first behavior is the cell reselection from a source cell to a target cell, and the target configuration information includes the first configuration information and the second configuration information.

The first configuration information includes a mapping from a QoS flow for the multicast service to an MRB in the source cell, and the second configuration information includes a mapping from a QoS flow for the multicast service to an MRB in the target cell.

Optionally, the first behavior is the cell reselection from the source cell to the target cell; and the first processing module is specifically configured to:
when determining, according to the target configuration information, that a state variable that is of the PDCP entity and that corresponds to the source cell cannot be used in the target cell, re-establish or reset, after the terminal reselects to the target cell, the PDCP entity of the MRB;
or
when determining, according to the target configuration information, that a state variable that is of the PDCP entity and that corresponds to the source cell cannot be used in the target cell, switch, after the terminal reselects to the target cell, from a non-connected state to a connected state, and re-establish the PDCP entity of the MRB or process the PDCP entity of the MRB of the multicast service according to indication information received from a network side device.

Optionally, the apparatus further includes a first setting module, specifically configured to:
after re-establishing or resetting, after the terminal reselects to the target cell, the PDCP entity of the MRB, or after switching, after the terminal reselects to the target cell, from the non-connected state to the connected state, and re-establishing the PDCP entity of the MRB or processing the PDCP entity of the MRB of the multicast service according to the indication information received from the network side device, set an initial value of the state variable of the PDCP entity according to a PDCP SN of a 1^{st} data packet received in the target cell;
or
after re-establishing or resetting, after the terminal reselects to the target cell, the PDCP entity of the MRB, or after switching, after the terminal reselects to the target cell, from the non-connected state to the connected state, and re-establishing the PDCP entity of the MRB or processing the PDCP entity of the MRB of the multicast service according to the indication information received from the network side device, receive a first state variable value, and set an initial value of the state variable of the PDCP entity based on the first state variable value.

Optionally, the first state variable value is carried in a multicast control channel MCCH of the target cell or carried in dedicated signaling.

Optionally, the first state variable value includes a suggested COUNT value or a suggested hyper frame number HFN value.

Optionally, the first behavior is the state switching, and the state switching is switching from a non-connected state to a connected state; and the first processing module is specifically configured to:
when determining, according to the target configuration information, that a COUNT value or a sequence number SN of the PDCP entity is synchronized or not synchronized before and after performing state switching, perform one of the following:
after being switched from the non-connected state to the connected state, re-establishing or resetting the PDCP entity of the MRB; and
after being switched from the non-connected state to the connected state, processing the PDCP entity of the MRB of the multicast service according to indication information received from a network side device.

Optionally, the apparatus further includes a target execution module, specifically configured to:
perform a first operation when the first behavior is the state switching, and maintaining the current state of the PDCP entity of the MRB, where the first operation includes at least one of the following: maintaining a current state of a radio link control RLC entity of the MRB, or maintaining a state and an operation that are related to the multicast service and that are of a media access control MAC entity of the MRB;
or
perform a second operation when the first behavior is the cell reselection, and maintaining the current state of the PDCP entity of the MRB, where the second operation includes at least one of the following: re-establishing or resetting an RLC entity of the MRB, or resetting a state and an operation that are related to the multicast service and that are of a MAC entity of the MRB;
or
perform a third operation when re-establishing or resetting the PDCP entity of the MRB, where the third operation includes at least one of the following: re-establishing or resetting an RLC entity of the MRB, or resetting a state and an operation that are related to the multicast service and that are of a MAC entity of the MRB.

The multicast service processing apparatus in this embodiment of this application may be an electronic device, for example, an electronic device having an operating system, or may be a component in the electronic device, for example, an integrated circuit or a chip. The electronic device may be a terminal or a device other than the terminal. For example, the terminal may include, but is not limited to, a type of the terminal 11 listed above. The device may be a server, a Network Attached Storage (NAS), or the like. This is not specifically limited in this embodiment of this application.

The multicast service processing apparatus provided in this embodiment of this application can implement the processes implemented in the method embodiment in FIG. 2 and achieves the same technical effects. To avoid repetition, details are not described herein again.

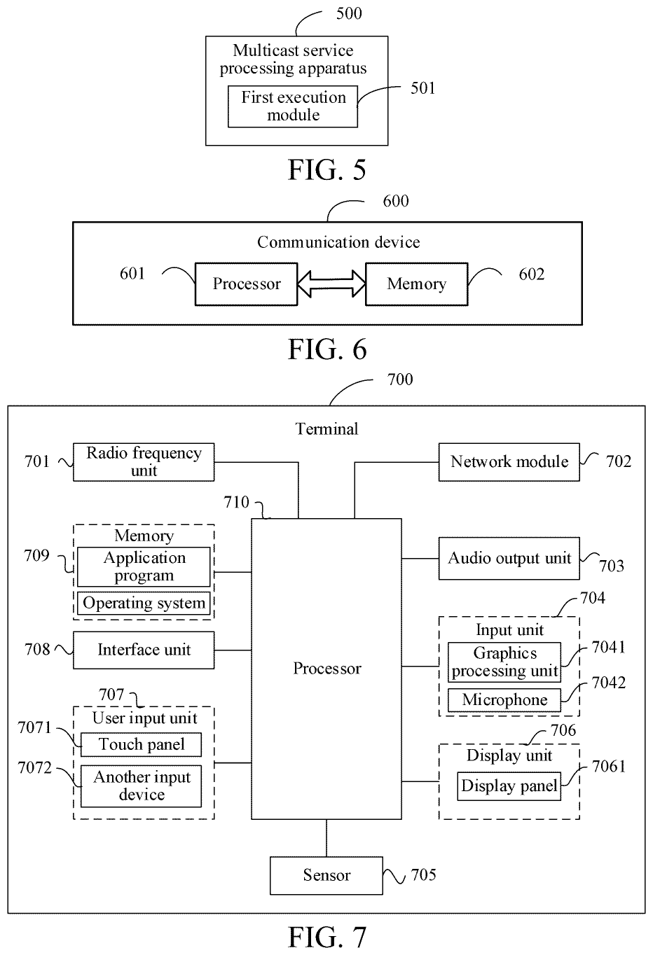

Refer to FIG. 5. FIG. 5 is a structural diagram of a multicast service processing apparatus according to an embodiment of this application. As shown in FIG. 5, the multicast service processing apparatus 500 includes:
a first execution module 501, configured to perform a fourth operation when a terminal that joins a multicast service performs a first behavior.

The first behavior includes cell reselection or state switching, and the fourth operation includes at least one of the following:
configuring the terminal to synchronize state information of a packet data convergence protocol PDCP entity of a multicast radio bearer MRB of the multicast service before and after performing the first behavior; or
at least one of first indication information or second indication information, where the first indication information is used for determining that the state information of the PDCP entity is synchronized or not synchronized before and after the first behavior is performed, and the second indication information is used for indicating the terminal to process the PDCP entity after performing the first behavior.

Optionally, the state switching is switching from a connected state to a non-connected state, or the state switching is switching from the non-connected state to the connected state.

Optionally, the configuring the terminal to synchronize state information of a packet data convergence protocol PDCP entity of a multicast radio bearer MRB of the multicast service before and after performing the first behavior includes:
configuring the terminal to synchronize a COUNT value or an SN of the PDCP entity of the MRB of the multicast service before and after performing the first behavior;
or
configuring mappings from a QoS flow for the multicast service to an MRB in a source cell and a target cell to be the same, where the first behavior is cell reselection from the source cell to the target cell.

Optionally, the first behavior is the cell reselection from the source cell to the target cell, and the first indication information is used for indicating at least one of the following:
the COUNT value or the SN of the PDCP entity is synchronized or not synchronized between the source cell and the target cell;
at least one first cell, where each first cell is synchronized with the source cell with respect to a COUNT value or an SN of a PDCP entity of a same MRB; or at least one second cell, where each second cell is synchronized with the target cell with respect to the COUNT value or the SN of the PDCP entity of the same MRB.

Optionally, the first behavior is the cell reselection from the source cell to the target cell; and the apparatus further includes:
a sending module, configured to send a first state variable value, where the first state variable value is used for setting an initial value of a state variable of the PDCP entity after the terminal reselects to the target cell.

Optionally, the first state variable value is carried in a multicast control channel MCCH of the target cell or carried in dedicated signaling.

Optionally, the first state variable value includes a suggested COUNT value or a suggested hyper frame number HFN value.

The multicast service processing apparatus in this embodiment of this application may be an electronic device, for example, an electronic device having an operating system, or may be a component in the electronic device, for example, an integrated circuit or a chip. The electronic device may be a network side device or a device other than the network side device. For example, the network side device may include, but is not limited to, a type of the network side device 12 listed above. The device may be a server, a Network Attached Storage (NAS), or the like. This is not specifically limited in this embodiment of this application.

The multicast service processing apparatus provided in this embodiment of this application can implement the processes implemented in the method embodiment in FIG. 3 and achieves the same technical effects. To avoid repetition, details are not described herein again.

Optionally, as shown in FIG. 6, an embodiment of this application further provides a communication device 600, including a processor 601 and a memory 602. The memory 602 stores a program or instructions runnable on the processor 601. For example, when the communication device 600 is a terminal, the program or the instructions, when being executed by the processor 601, implement the steps of the multicast service processing method embodiment, and can achieve the same technical effects. When the communication device 600 is a network side device, the program or the instructions, when being executed by the processor 601, implement the steps of the multicast service processing method embodiment, and can achieve the same technical effects. To avoid repetition, details are not described herein again.

An embodiment of this application further provides a terminal, including a processor and a communication interface. The processor is configured to: when a terminal joins a multicast service, if the terminal performs a first behavior, process a packet data convergence protocol PDCP entity of a multicast radio bearer MRB of the multicast service according to target configuration information. The first behavior includes cell reselection or state switching, and the target configuration information includes at least one of the following: first configuration information, second configuration information, first indication information, quality of service QoS requirement information of the multicast service, or second indication information. The first configuration information is configuration information of the MRB before the first behavior is performed, the second configuration information is configuration information of the MRB after the first behavior is performed, the first indication information is used for determining that state information of the PDCP entity is synchronized or not synchronized before and after the first behavior is performed, and the second indication information is used for indicating the terminal to process the PDCP entity after performing the first behavior. The terminal embodiment corresponds to the method embodiment on the terminal side, and each implementation process and each implementation of the method embodiment are applicable to the terminal embodiment and can achieve the same technical effects. Specifically, FIG. 7 is a schematic diagram of a hardware structure of a terminal according to an embodiment of this application.

The terminal 700 includes, but is not limited to, at least some components such as a radio frequency unit 701, a network module 702, an audio output unit 703, an input unit 704, a sensor 705, a display unit 706, a user input unit 707, an interface unit 708, a memory 709, and a processor 710.

A person skilled in the art may understand that the terminal 700 may further include a power supply (for example, a battery) for supplying power to the components. The power supply may be logically connected to the processor 710 by a power supply management system, thereby implementing functions, such as charging, discharging, and power consumption management, by using the power supply management system. A terminal structure shown in FIG. 7 does not constitute a limitation to the terminal, and the terminal may include more or fewer components than those shown in the figure, or some components may be combined, or a different component deployment may be used. Details are not described herein again.

It should be understood that in this embodiment of this application, the input unit 704 may include a Graphics Processing Unit (GPU) 7041 and a microphone 7042. The graphics processing unit 7041 performs processing on image data of a static picture or a video that is obtained by an image acquisition device (for example, a camera) in a video acquisition mode or an image acquisition mode. The display unit 706 may include a display panel 7061, for example, the display panel 7061 configured in a form such as a liquid crystal display or an organic light-emitting diode. The user input unit 707 includes at least one of a touch panel 7071 or another input device 7072. The touch panel 7071 is also referred to as a touchscreen. The touch panel 7071 may include two parts: a touch detection apparatus and a touch controller. The another input device 7072 may include, but not limited to, a physical keyboard, a functional key (for example, a volume control key or a switch key), a track ball, a mouse, and a joystick, which are not described herein in detail.

In this embodiment of this application, after receiving downlink data from the network side device, the radio frequency unit 701 sends the downlink data to the processor 710 for processing. In addition, the radio frequency unit 701 may send uplink data to the network side device. Generally, the radio frequency unit 701 includes, but is not limited to, an antenna, an amplifier, a transceiver, a coupler, a low noise amplifier, a duplexer, and the like.

The memory 709 may be configured to store a software program or instructions and various data. The memory 709 may mainly include a first storage area storing the program or the instructions and a second storage area storing data. The first storage area may store an operating system, an application program or instructions required by at least one function (for example, a sound playback function and an image display function), and the like. In addition, the memory 709 may include a volatile memory or a nonvolatile memory. The non-volatile memory may be a Read-Only Memory (ROM), a Programmable ROM (PROM), an erasable programmable read-only memory (Erasable PROM, EPROM), an Electrically EPROM (EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), or a direct rambus random access memory (Direct rambus RAM, DR RAM). The memory 709 in this embodiment of this application includes, but is not limited to, these memories and any other suitable types of memories.

The processor 710 may include one or more processing units. Optionally, the processor 710 integrates an application processor and a modem processor. The application processor mainly processes operations related to an operating system, a user interface, an application program, and the like. The modem processor mainly processes a wireless communication signal, for example, a baseband processor. It may be understood that the foregoing modem processor may either not be integrated into the processor 710.

The processor 710 is configured to: when a terminal joins a multicast service, if the terminal performs a first behavior, process a packet data convergence protocol PDCP entity of a multicast radio bearer MRB of the multicast service according to target configuration information. The first behavior includes cell reselection or state switching, and the target configuration information includes at least one of the following: first configuration information, second configuration information, first indication information, quality of service QoS requirement information of the multicast service, or second indication information. The first configuration information is configuration information of the MRB before the first behavior is performed, the second configuration information is configuration information of the MRB after the first behavior is performed, the first indication information is used for determining that state information of the PDCP entity is synchronized or not synchronized before and after the first behavior is performed, and the second indication information is used for indicating the terminal to process the PDCP entity after performing the first behavior.

It may be understood that, for an implementation process of each implementation mentioned in this embodiment, refer to the related descriptions in the foregoing method embodiments, and same or corresponding technical effects are achieved. To avoid repetition, details are not described herein again.

An embodiment of this application further provides a network side device, including a processor and a communication interface. The processor is configured to perform a fourth operation when a terminal that joins a multicast service performs a first behavior. The first behavior includes cell reselection or state switching, and the fourth operation includes at least one of the following: configuring the terminal to synchronize state information of a packet data convergence protocol PDCP entity of a multicast radio bearer MRB of the multicast service before and after performing the first behavior; or at least one of first indication information or second indication information, where the first indication information is used for determining that the state information of the PDCP entity is synchronized or not synchronized before and after the first behavior is performed, and the second indication information is used for indicating the terminal to process the PDCP entity after performing the first behavior. The network side device embodiment corresponds to the method embodiment on the network side device, and each implementation process and each implementation of the method embodiment are applicable to the network side device embodiment and can achieve the same technical effects.

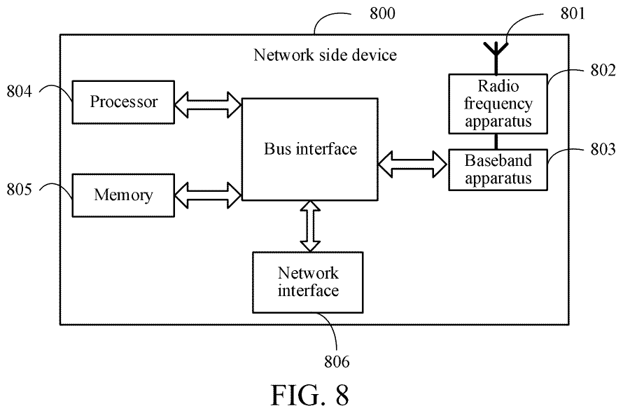

Specifically, an embodiment of this application further provides a network side device. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives, by using the antenna 801, information, and sends the received information to the baseband apparatus 803 for processing. In a downlink direction, the baseband apparatus 803 processes to-be-sent information, and sends the information to the radio frequency apparatus 802. The radio frequency apparatus 802 processes the received information and sends out the information by using the antenna 801.

The method performed by the network side device in the foregoing embodiments may be implemented in the baseband apparatus 803. The baseband apparatus 803 includes a baseband processor.

The baseband apparatus 803 may include, for example, at least one baseband plate. A plurality of chips are disposed on the baseband plate. As shown in FIG. 8, one of the plurality of chips is, for example, the baseband processor, and is connected to the memory 805 through a bus interface, to invoke a program in the memory 805 to perform operations of the network side device in the foregoing method embodiment.

The network side device may further include a network interface 806. The interface is, for example, a Common Public Radio Interface (CPRI).

Specifically, the network side device 800 in this embodiment of this application further includes: instructions or a program stored on the memory 805 and runnable on the processor 804. The processor 804 invokes the instructions or program in the memory 805 to perform the method performed by each module in FIG. 5, and the same technical effects are achieved. To avoid repetition, details are not described herein again.

An embodiment of this application further provides a readable storage medium. The readable storage medium stores a program or instructions. The program or the instructions, when being executed by a processor, implement the processes of the multicast service processing method embodiments, and the same technical effect can be achieved. To avoid repetition, details are not described herein again.

The processor is the processor in the terminal in the foregoing embodiments. The readable storage medium includes a computer-readable storage medium, for example, a ROM, a RAM, a magnetic disk, or an optical disc. In some examples, the readable storage medium may be a non-transitory readable storage medium.

An embodiment of this application further provides a chip. The chip includes a processor and a communication interface, where the communication interface is coupled to the processor, and the processor is configured to run a program or instructions, to implement the processes of the multicast service processing method embodiments, and the same technical effect can be achieved. To avoid repetition, details are not described herein again.

It should be understood that, the chip mentioned in this embodiment of this application may also be referred to as a system-level chip, a system chip, a chip system, a system on chip, or the like.

An embodiment of this application provides a computer program/program product. The computer program/program product is stored in a storage medium. The computer program/program product is executed by at least one processor to implement the processes of the multicast service processing method embodiments, and the same technical effect can be achieved. To avoid repetition, details are not described herein again.

An embodiment of this application further provides a multicast service processing system, including: a terminal and a network side device, the terminal is configured to perform the processes in FIG. 2 and the foregoing method embodiments, the network side device is configured to perform the processes in FIG. 3 and the foregoing method embodiments, and the same technical effects can be achieved. To avoid repetition, details are not described herein again.

It should be noted that, the terms “include”, “including”, or any other variation thereof in this specification is intended to cover a non-exclusive inclusion, which specifies the presence of stated processes, methods, objects, or apparatuses, but do not preclude the presence or addition of one or more other processes, methods, objects, or apparatuses. Without more limitations, elements defined by the sentence “including one” does not exclude that there are still other same elements in the processes, methods, objects, or apparatuses. In addition, it should be noted that, the scope of the methods and apparatuses in the implementations of this application is not limited to performing the functions in the order shown or discussed, but may further include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

Based on the foregoing descriptions of the implementations, a person skilled in the art may clearly understand that the method in the foregoing embodiments may be implemented by a computer software product in addition to a necessary general hardware platform or by hardware. The computer software product is stored in a storage medium (for example, a ROM, a RAM, a magnetic disk, or an optical disc) and includes a plurality of instructions for instructing the terminal or the network side device to perform the method described in the embodiments of this application.

The embodiments of this application are described above with reference to the accompanying drawings. However, this application is not limited to the foregoing specific implementations. The foregoing specific implementations are illustrative instead of limitative. Enlightened by this application, a person of ordinary skill in the art can make implementations of many forms without departing from the idea of this application and the scope of protection of the claims. All of the forms fall within the protection of this application.

What is claimed is:

1. A multicast service processing method, comprising:
when a terminal joins a multicast service, if the terminal performs a first behavior, processing, by the terminal, a packet data convergence protocol PDCP entity of a multicast radio bearer MRB of the multicast service according to target configuration information, wherein
the first behavior comprises cell reselection or state switching, and the target configuration information comprises first indication information; and
the first indication information is used for determining that state information of the PDCP entity is synchronized or not synchronized before and after the first behavior is performed.

2. The method according to claim 1, wherein the processing, by the terminal, a PDCP entity of an MRB of the multicast service according to target configuration information comprises:
when determining, according to the target configuration information, that a count COUNT value or a sequence number SN of the PDCP entity is synchronized before and after performing the first behavior, maintaining, by the terminal, a current state of the PDCP entity of the MRB;
or
when determining, according to the target configuration information, that a COUNT value or an SN of the PDCP entity is not synchronized before and after performing the first behavior, re-establishing or resetting, by the terminal, the PDCP entity of the MRB.

3. The method according to claim 1, wherein the first behavior is the cell reselection from a source cell to a target cell, and the target configuration information comprises the first indication information; and
the first indication information is used for indicating at least one of the following:
the COUNT value or the SN of the PDCP entity is synchronized or not synchronized between the source cell and the target cell;
at least one first cell, wherein each first cell is synchronized with the source cell with respect to a COUNT value or an SN of a PDCP entity of a same MRB; or
at least one second cell, wherein each second cell is synchronized with the target cell with respect to the COUNT value or the SN of the PDCP entity of the same MRB.

4. The method according to claim 1, wherein the first behavior is the cell reselection from a source cell to a target cell; and
the processing, by the terminal, a PDCP entity of an MRB of the multicast service according to target configuration information comprises:
when determining, according to the target configuration information, that a state variable that is of the PDCP entity and that corresponds to the source cell cannot be used in the target cell, re-establishing or resetting, by the terminal after reselecting to the target cell, the PDCP entity of the MRB;
or
when determining, according to the target configuration information, that a state variable that is of the PDCP entity that corresponds to the source cell cannot be used in the target cell, switching, by the terminal after reselecting to the target cell, from a non-connected state to a connected state, and re-establishing the PDCP entity of the MRB or processing the PDCP entity of the MRB of the multicast service according to indication information received from a network side device.

5. The method according to claim 4, wherein after the re-establishing or resetting, by the terminal after reselecting to the target cell, the PDCP entity of the MRB, or after the switching, by the terminal after reselecting to the target cell, from a non-connected state to a connected state, and re-establishing the PDCP entity of the MRB or processing the PDCP entity of the MRB of the multicast service according to indication information received from a network side device, the method further comprises:
setting, by the terminal, an initial value of the state variable of the PDCP entity according to a PDCP SN of a 1^{st} data packet received in the target cell;
or
receiving, by the terminal, a first state variable value, and setting an initial value of the state variable of the PDCP entity based on the first state variable value.

6. The method according to claim 5, wherein the state variable of the PDCP entity comprises at least one of the following:
a reception variable for delivery to a high layer;
a next reception variable; or
a reordering reception variable.

7. The method according to claim 6, wherein the setting, by the terminal, an initial value of the state variable of the PDCP entity according to a PDCP SN of a 1^{st} data packet received in the target cell comprises at least one of the following:
setting, by the terminal, an SN initial value of the next reception variable of the PDCP entity according to the PDCP SN of the 1^{st} data packet; or
setting, by the terminal, an SN initial value of the reception variable for delivery to a high layer of the PDCP entity according to the PDCP SN of the 1^{st} data packet.

8. The method according to claim 5, wherein the first state variable value is carried in a multicast control channel MCCH of the target cell or carried in dedicated signaling.

9. The method according to claim 5, wherein the first state variable value comprises a suggested COUNT value or a suggested hyper frame number HFN value.

10. The method according to claim 1, wherein the first behavior is the state switching, and the state switching is switching from a non-connected state to a connected state; and
the processing, by the terminal, a PDCP entity of an MRB of the multicast service according to target configuration information comprises:
when determining, according to the target configuration information, that a COUNT value or a sequence number SN of the PDCP entity is synchronized or not synchronized before and after performing state switching, performing, by the terminal, one of the following:
after being switched from the non-connected state to the connected state, re-establishing or resetting the PDCP entity of the MRB; and
after being switched from the non-connected state to the connected state, processing the PDCP entity of the MRB of the multicast service according to indication information received from a network side device.

11. The method according to claim 1, further comprising:
performing, by the terminal, a first operation when the first behavior is the state switching, and the terminal maintains the current state of the PDCP entity of the MRB, wherein the first operation comprises at least one of the following: maintaining a current state of a radio link control RLC entity of the MRB, or maintaining a state and an operation that are related to the multicast service and that are of a media access control MAC entity of the MRB;
or
performing, by the terminal, a second operation when the first behavior is the cell reselection, and the terminal maintains the current state of the PDCP entity of the MRB, wherein the second operation comprises at least one of the following: re-establishing or resetting an RLC entity of the MRB, or resetting a state and an operation that are related to the multicast service and that are of a MAC entity of the MRB;
or
performing, by the terminal, a third operation when the terminal re-establishes or resets the PDCP entity of the MRB, wherein the third operation comprises at least one of the following: re-establishing or resetting an RLC entity of the MRB, or resetting a state and an operation that are related to the multicast service and that are of a MAC entity of the MRB.

12. A multicast service processing method, comprising:
performing, by a network side device, a fourth operation when a terminal that joins a multicast service performs a first behavior, wherein
the first behavior comprises cell reselection or state switching, and the fourth operation comprises at least one of the following:
configuring the terminal to synchronize state information of a packet data convergence protocol PDCP entity of a multicast radio bearer MRB of the multicast service before and after performing the first behavior; or
first indication information, wherein the first indication information is used for determining that the state information of the PDCP entity is synchronized or not synchronized before and after the first behavior is performed.

13. The method according to claim 12, wherein the configuring the terminal to synchronize state information of a packet data convergence protocol PDCP entity of a multicast radio bearer MRB of the multicast service before and after performing the first behavior comprises:
configuring the terminal to synchronize a COUNT value or an SN of the PDCP entity of the MRB of the multicast service before and after performing the first behavior;
or
configuring mappings from a QoS flow for the multicast service to an MRB in a source cell and a target cell to be the same, wherein the first behavior is cell reselection from the source cell to the target cell.

14. The method according to claim 12, wherein the first behavior is the cell reselection from the source cell to the target cell, and the first indication information is used for indicating at least one of the following:
the COUNT value or the SN of the PDCP entity is synchronized or not synchronized between the source cell and the target cell;
at least one first cell, wherein each first cell is synchronized with the source cell with respect to a COUNT value or an SN of a PDCP entity of a same MRB; or
at least one second cell, wherein each second cell is synchronized with the target cell with respect to the COUNT value or the SN of the PDCP entity of the same MRB.

15. The method according to claim 12, wherein the first behavior is the cell reselection from the source cell to the target cell; and the method further comprises:
sending, by the network side device, a first state variable value, wherein the first state variable value is used for setting an initial value of a state variable of the PDCP entity after the terminal reselects to the target cell.

16. The method according to claim 15, wherein the first state variable value is carried in a multicast control channel MCCH of the target cell or carried in dedicated signaling.

17. The method according to claim 15, wherein the first state variable value comprises a suggested COUNT value or a suggested hyper frame number HFN value.

18. A terminal, comprising a processor and a memory, wherein the memory stores a program or instructions runnable on the processor, and the program or the instructions, when being executed by the processor, implement a multicast service processing method,
wherein the multicast service processing method comprises:
when the terminal joins a multicast service, if the terminal performs a first behavior, processing, by the terminal, a packet data convergence protocol PDCP entity of a multicast radio bearer MRB of the multicast service according to target configuration information, wherein
the first behavior comprises cell reselection or state switching, and the target configuration information comprises first indication information; and
the first indication information is used for determining that state information of the PDCP entity is synchronized or not synchronized before and after the first behavior is performed.

19. A network side device, comprising a processor and a memory, wherein the memory stores a program or instructions runnable on the processor, and the program or the instructions, when being executed by the processor, implement the steps of the multicast service processing method according to claim 12.

20. A non-transitory readable storage medium, wherein the readable storage medium stores a program or instructions, and the program or the instructions, when being executed by a processor, implement the steps of the multicast service processing method according to claim 1.
